(19) United States
(12) Patent Application Publication
(10) Pub. No.: US 2025/0091169 A1
(43) Pub. Date: Mar. 20, 2025

(54) PROTECTIVE DEVICE WITH TIME-OF-FLIGHT ARRAY FOR PROVIDING SAFETY MONITORING OF A MACHINE AND RELATED METHODS

(71) Applicant: Datalogic IP Tech S.r.l., Calderara Di Reno (IT)

(72) Inventors: Enrico Lorenzoni, Zola Predosa (IT); Salvatore Valerio Cani, Bologna (IT)

(21) Appl. No.: 18/882,021

(22) Filed: Sep. 11, 2024

Related U.S. Application Data
(60) Provisional application No. 63/583,213, filed on Sep. 15, 2023.

(51) Int. Cl. B23Q 11/00; B27G 21/00; G05B 19/406

(52) U.S. Cl. CPC B23Q 11/0092; B23Q 11/0089; G05B 19/406; B27G 21/00; G05B 2219/34465

(57) ABSTRACT

The disclosure includes a protective device for a machine, a method of operating a protective device, and a protective system including the protective device and the machine. The protective device may include a sensor array disposed on the machine. The sensor array may have a plurality of time-of-flight (TOF) sensors arranged to form a sensible field for TOF measurements, and a controller configured to define a safety area within the sensible field, detect an object within the sensible field, and generate a safety output that controls an operation of the machine in response to the object being detected within the safety area. The machine may include woodworking machines or other machines having debris or particles in the surrounding environment during operation.

### CROSS-REFERENCE TO RELATED APPLICATION

This application claims the benefit under 35 U.S.C. § 119(e) of U.S. Provisional Application Ser. No. 63/583,213, filed Sep. 15, 2023, the content of which is incorporated by reference herein in its entirety.

### TECHNICAL FIELD

The present disclosure relates generally to protective monitoring of a machine, and more particularly, to protective devices including a time-of-flight array employed to monitor an area around a machine having a movable portion.

### BACKGROUND

Safety laser scanners have been employed in various applications of safe monitoring areas of static areas, such as robot cells, machine perimeters, machine openings, etc., as well as dynamic applications, such as automated guided vehicles, automated guided carts, forklifts, etc. For some applications, such as wood working machinery, a certain dimension of pollution (e.g., dust, debris, etc.) may be detected as a stop condition that may result in stopping operation of the machine during normal operation when there is no actual safety hazard present. As such, there is a need for a protective device that can reduce the number of false positives when employed in an environment.

### BRIEF SUMMARY

A protective device for a machine, comprising: a sensor array disposed on the machine, the sensor array having a plurality of time-of-flight (TOF) sensors arranged to form a sensible field for TOF measurements; and a controller operably coupled to the sensor array, the controller configured to: define a safety area within the sensible field; detect an object within the sensible field; and generate a safety output that controls an operation of the machine in response to the object being detected within the safety area.

A method of operating a protective device comprises: projecting a sensible field for TOF measurements from a sensor array having a plurality of time-of-flight (TOF) sensors disposed on a machine; and defining, via a controller of a protective device, a safety area within the sensible field of the sensor array; detecting an object within the sensible field via the controller coupled to the sensor array; and generating a safety output that controls an operation of the machine in response to the object being detected within the safety area.

A protective system comprises a machine; a protective device disposed on the machine for providing safety monitoring around the machine, the protective device comprising: a sensor array disposed on the machine, the sensor array having a plurality of time-of-flight (TOF) sensors arranged to form a sensible field for TOF measurements; and a controller operably coupled to the sensor array, the controller configured to: define a safety area within the sensible field; detect an object within the sensible field; and generate a safety output that controls an operation of the machine in response to the object being detected within the safety area.

### BRIEF DESCRIPTION OF THE DRAWINGS

Illustrative embodiments of the present invention are described in detail below with reference to the attached drawing figures, which are incorporated by reference herein and wherein:

FIG. 1 is a simplified block diagram for a system in which a protective device may be used in conjunction with a machine for the safety monitoring thereof;

FIGS. 2A and 2B show various views of a simplified machine having the protective device installed thereon;

FIG. 3 is a simplified block diagram of a protective device according to an embodiment of the disclosure;

FIGS. 4A-4C show the sensor array with its corresponding sensible field and defined safety area, along with corresponding control safety outputs by the controller in response to various scenarios according to embodiments of the disclosure;

FIG. 5 shows an example detectable object represented by a cylinder of suitable diameter to illustrate the detection capability of the protection device; and

FIG. 6 is a flow chart illustrating a method for operating a scan sequence of the protective device according to an embodiment of the disclosure.

### DETAILED DESCRIPTION

The illustrations included herewith are not meant to be actual views of any particular systems, memory device, architecture, or process, but are merely idealized representations that are employed to describe embodiments herein. Elements and features common between figures may retain the same numerical designation except that, for ease of following the description, for the most part, reference numerals begin with the number of the drawing on which the elements are introduced or most fully described. In addition, the elements illustrated in the figures are schematic in nature, and many details regarding the physical layout and construction of a memory array and/or all steps necessary to access data may not be described as they would be understood by those of ordinary skill in the art.

As used herein, the singular forms “a,” “an,” and “the” are intended to include the plural forms as well, unless the context clearly indicates otherwise.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operably connected with each other, such as connected through a direct connection or through an indirect connection (e.g., via another structure or component).

Embodiments of the disclosure relate to a protective device including a series of time-of-flight (TOF) sensors aligned with a criterion and controlled by a control unit in order to create a generally rectangular sensible detection field, the extension of which may be programmed from an appropriate user interface. The protective device may be used in a variety of applications in which particles, such as dust and/or debris, may be falsely identified as a safety threat that causes a stop condition or the machine. For example, the protective device may be disposed in the movable head of an automatic woodworking machine. In such an environment, the protective device may replace a safety laser scanner that has been typically used in monitoring of such machines, but which can exhibit poor resistance to dust and processing debris.

Embodiments of the disclosure may increase the immunity to particle pollution (e.g., dust, debris, etc.) by use of a plurality of TOF sensors arranged in a beam array suitable for a particular application. The TOF sensor array may be disposed on an external system of the machine, such as a movable head of a woodworking machine. In some embodiments, another TOF sensor may also be disposed on the machine to determine a position of the movable portion of the machine, which information may be used to adjust the safety area monitored by the TOF sensor array. By installing the protective device on a movable portion of the machine itself, fixed installation of the protective device in an area around the machine is not required which can provide flexibility in the placement of the machinery without needing to change the location or installation of the protective device.

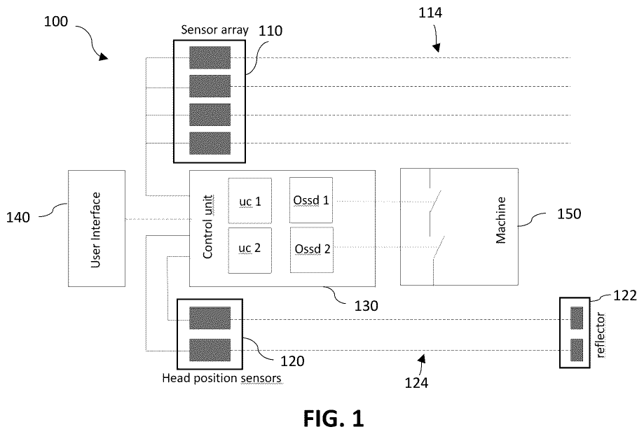

FIG. 1 is a simplified block diagram for a system in which a protective device 100 may be used in conjunction with a machine 150 for the safety monitoring thereof. The protective device 100 includes a first group of TOF sensors 110 (also referred to as a “sensor array”) and a second group of TOF sensors 120 (also referred to as “head position sensor(s)” or “position sensor(s)”) operably coupled with a controller 130 (also referred to as a “control unit”). The controller 130 may also be operably coupled with a user interface 140 for receiving inputs from a user, and also operably coupled with the machine 150 to send control signals thereto.

The sensor array 110 may include a first number (N) of TOF sensors arranged in a parallel sensor array to have a generally rectangular sensible field 114 (also referred to as the “safety field”). The first number N of TOF sensors may be an integer greater than one (i.e., a plurality of TOF sensors). The particular number N of TOF sensors used for a particular application may depend on the dimensions (e.g., height, width) of the desired safety area and the detection capability to achieve via the sensible field 114.

The head position sensor 120 may include a second number (M) of TOF sensors that are used in conjunction with reflectors 122 as an accurate measuring sensor instead of an encoder on the machine 150. In some embodiments, the second number M of TOF sensors may be one TOF sensor or a plurality of TOF sensors depending on the desired safety integrity level (SIL) and/or performance level (PL) (i.e., one or more TOF sensors). In some embodiments, the maximum number for M may be two in certain applications.

In the machine 150, it may be desirable for the width of the safety area 115 to be variable according to the positioning of the working head. This is to avoid, for example, that near the limit of working area, there is a safety area that exceeds the shape of the machine and can be intercepted by an object in the work environment, which may cause unwanted stops. In some embodiments, an encoder may be employed by the machine 150. However, it may be desirable for some applications for such an encoder to only be used for the machine functionality and not to be available for external units, such as the protective device 100.

Thus, the head position sensor 120 may act as an independent measuring sensor that is fixed to the working head and with an adequate precision for the safety function. The choice falls on a long distance TOF sensor and a corresponding reflector panel. The use of this sensor may allow to have an accuracy of the order of ⅝ mm up to 20 m. The use of the retroreflector panel enables a much higher immunity to dust and the response times can be set high for the same purpose. The reflector may be disposed on the body of the machine 150, which remains stationary, near the end of the shape.

The output of the head position sensor 120 may be transmitted to the control unit 130 through a bus (e.g., RS485) or analog, with the output providing an indication of the position of the movable head respect to a reference origin. Although the head position sensor 120 may include a single TOF sensor, some applications may require redundancy in order to make the function safe with an appropriate level. As a result, the head position sensor 120 may include a plurality of TOF sensors. The number of TOF sensors may vary up to a maximum of 2 in some embodiments in order to have the adequate safety level (SIL 2). In this embodiment, the second TOF sensor can be placed in the same way as the first TOF sensor, but at a different height and so that it does not interfere with the first, or in contrast to the first, so that, given a direction of movement of the head, the first TOF sensor has gradually decreasing measures, and the second TOF sensor on the contrary gradually increasing. The controller 130 may be configured to verify that the two measures are in any case consistent.

The controller 130 may be configured to control the reading process of the sensor array 110 (e.g., drive, configure settings, timing, receive data, etc.) via one or more processors (e.g., microprocessor (up), microcontroller, FPGA, etc.). The controller 130 may also be configured to control operation of the machine 150 via output switching safety device(s) (OSSDs) that are responsive to the results of the TOF sensors array 110 according to a target safety level.

The user interface 140 may include a mechanical device (e.g., button) and/or an electronic display (e.g., touch screen) configured for interfacing with the user to receive commands, such as setting the safety zone.

In some embodiments, the sensor array 110, head position sensor 120, controller 130, and/or the user interface 140 may be incorporated into a common physical device with a common housing. In some embodiments, certain elements may be physically separated from each other in separate housings, which may communicate with each other via wired or wireless connections as desired for a particular application.

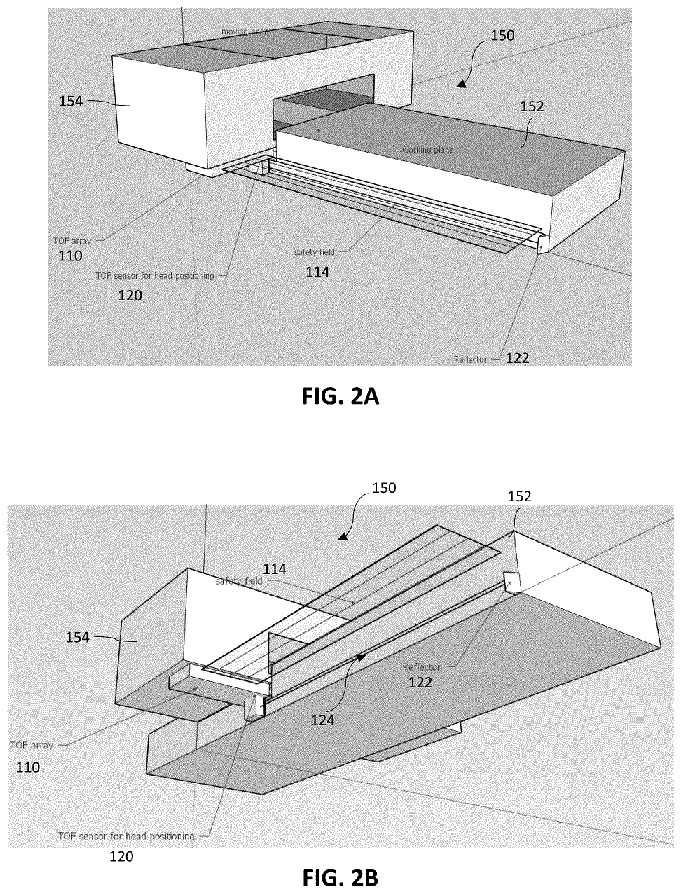

FIGS. 2A and 2B show various views of a simplified machine (such as the machine 150 of FIG. 1) having the protective device 100 installed thereon. FIG. 2A is a top perspective view of the machine 150 and FIG. 2B is a bottom view of the machine 150. The machine 150 may include a working plane 152 and a movable head 154. As described above, the machine 150 may be a woodworking machine or other machine having a stationary working surface with a movable portion.

The sensor array 110 may be disposed on a portion of the movable head 154 with the sensible field 114 extending alongside the working plane 152 of the machine 150. Thus, the sensor array 110 and the sensible field 114 may move along with the movable head 154 of the machine 150. In some embodiments, the head position sensor 120 may also be disposed on a portion of the movable head 154 and its corresponding reflector 122 may be disposed on the body of the working plane 152 of the machine 150. In this arrangement, the positioning field 124 may extend across the body of the working plane 152 substantially parallel to, and below, the sensible field 114. Other arrangements are also contemplated. For example, the head position sensor 120 and its corresponding reflector 122 may be disposed on the other side of the movable head 154 and working plane 152 from where the sensor array 110 is disposed. In some embodiments, the position of the head position sensor 120 and the reflector 122 may be reversed such that the reflector 122 is disposed on the movable head 154 and the head position sensor 120 is disposed on the body of the working plane 152, although the head position sensor 120 may be disposed together with the sensor array 110 in order to simplify connections to the controller 130.

As shown in FIGS. 2A and 2B, the protective device may be disposed on one side of the machine 150 to protect one side of the working area. In some embodiments, another protective device may be disposed on another side of the machine 150 to protect another side of the working area. The second protective device (and/or any other additional protective devices) may be similarly configured and arranged in a way that protects the desired region depending on the specific configuration/operation of the machine, where the machine is installed, and the surrounding environment.

In operation, the individual sensors of the TOF sensor array 110 may be activated by the controller 130. In some embodiments, the activation may be sequential or some other method. Time-of-flight measurements may be determined by the TOF sensors of the sensor array 110. The controller 130 may be configured to perform activation control of the TOF sensor array 110, such as for their reading, for their safety integrity check, and for providing control safety outputs (e.g., (OSSDs)) according to a specific safety function. The controller 130 may also manage the user interface 140, through which the user may determine the width of the safety area by managing the switching thresholds of the measurement sensors of the TOF sensor array 110. Through the user interface 140, the user may be able to set switching thresholds for definition of the switching area. This switching area corresponds to the safety area for intrusion detection. In some embodiments, a single switching threshold may be defined. In other embodiments, multiple switching thresholds may be defined.

The controller 130 also receives the output of the head position sensor 120 integrated on the mobile head of the machine 150. The head position sensor 120 establishes the relative position of the movable head 154 with respect to the working plane 152 of the machine 150. In some embodiments, the safety zones for the TOF sensor array 110 may be adjusted responsive to the output of the head position sensor 120.

A common setting of the switching thresholds applied to all sensors of the TOF sensor array 110 may result in the safety area being generally rectangular shaped. In some embodiments, a different management of the switching thresholds for the sensor outputs can allow greater flexibility for a customized shape of a safety zone. In other words, the user interface 140 may allow the user to manage a customized zone in the controller 130 by independently setting the switching threshold of each sensor within the TOF sensor array 110 to different values. Thus, the switching threshold for each sensor of the TOF sensor array 100 may be set according to any desired criteria, such as convenience of design, the usage for a particular application, etc.

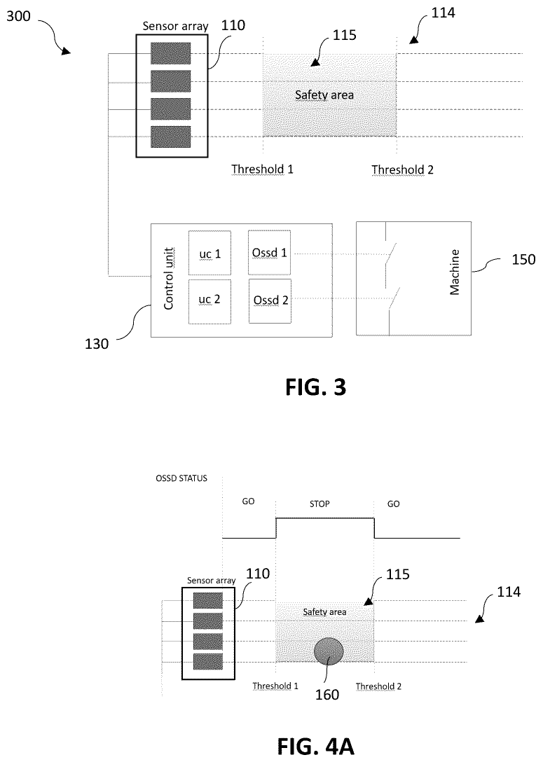

FIG. 3 is a simplified block diagram of a protective device 300 according to an embodiment of the disclosure. The protective device 300 includes a sensor array 110 and controller 130 configured as described above. In this particular example shown, the sensor array 110 includes four individual TOF sensors that create the sensible field 114. Of course, any number of individual TOF sensors are contemplated so long as there are multiple individual TOF sensors for the sensor array 110. The TOF sensors of the sensor array 110 may be disposed to be equidistant from each other so that the distance between two consecutive TOF beams corresponds to the detection capability minus the maximum diameter of the emission beam spot. The TOF sensors may also be aligned so that they remain parallel to each other within the entire maximum detection distance for the sensible field 114. For example, the TOF sensors of the sensor array 110 may be aligned such that their emission beams remain substantially parallel through at least the safety area 115.

The user interface and head position sensor are not shown in FIG. 3, but it should be understood that such elements may be present in some embodiments. The focus of FIG. 3 is on the definition of the safety area 115 monitored by the sensor array 110. The safety area 115 may be defined as region of the sensible field 114 based on one or more triggering thresholds. In the example shown in FIG. 3, a first triggering threshold (“Threshold 1”) and a second triggering threshold (“Threshold 2”) are provided with the safety area 115 being defined as the region between the first and second thresholds. In this example, the values for the first and second thresholds are common among all TOF sensors of the sensor array 110, thereby creating a substantially rectangular safety area 115. In some embodiments, different TOF sensors of the sensors of the sensor array 110 may have different threshold values creating a safety area 115 having a different shape. For example, the first two TOF sensors of the sensor array 110 may have different threshold values than the third and fourth TOF sensors of the sensor array 110 (using the example of FIG. 3 with four TOF sensors shown). In some embodiments, each TOF sensor of the sensor array 110 may have different threshold values to create a desired shape for the safety area 115.

The implementation of the first threshold in open field applications (i.e., where the introduction of a human being is possible because there is no other protection) could be changed. In some embodiments, the zone in the sensible field 114 before the first threshold may be handled by the controller 130 similar to the safety area 115. Because any intrusion in that zone could cause the loss of detection capability in the safety area 115, the controller 130 may nevertheless generate a stop command. However, in specific applications, the zone before the first threshold could be physically unreachable and/or protected by a mechanical system, and in any case be defined with different filtering rules with respect to detection than those of the safety area 115. As a result, embodiments of the disclosure may be more robust with respect to immunity to dust contributing to a greater overall availability of the safety device.

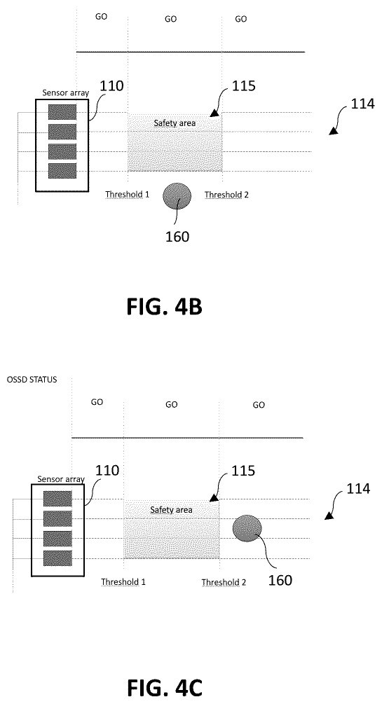

FIGS. 4A-4C show the sensor array 110 with its corresponding sensible field 114 and defined safety area 115, along with corresponding control safety outputs (e.g., (OSSDs)) by the controller in response to various scenarios according to embodiments of the disclosure.

As shown in FIG. 4A, an object 160 may enter the sensible field 114 within the safety area 115. In this example, two of the TOF sensors (e.g., the bottom two sensors) of the sensor array 110 may detect the presence of the object 160 to be within the safety area 115, causing the OSSDs status to be “STOP” causing the controller 130 to output a stop command to the machine 150.

As shown in FIG. 4B, the object 160 may be located outside of the sensible field 114 of the sensor array 110. As a result, no TOF sensors of the sensor array 110 detect its presence, causing the OSSDs status to be “GO.” As a result, the machine may continue to operate.

As shown in FIG. 4C, the object 160 may be located within the sensible field 114 of the sensor array 110, but outside of the safety area 115. In this example, two of the TOF sensors (e.g., the middle two sensors) of the sensor array 110 may detect the presence of the object 160 at a distance that is beyond the second threshold defining the safety area 115. As a result, the OSSDs status to be “GO.” As a result, the machine may continue to operate.

These three examples are not intended to be exhaustive of the scenarios in which objects may be detected by the sensor array 110. For example, the object 160 may be detected by the sensor array 110 at a distance that is to the left of the first threshold as viewed in these figures. The controller may be configured to handle this scenario as a different status may also result in a STOP status because a detection of an object in this portion may obscure the contemporary detection of a different object within the safety area 115. Such a situation may also result in an alert that informs the user about the object 160 being detected to the left of the first threshold as being the reason for the STOP status. In some embodiments, a second array may be implemented in the opposite direction which may allow the system to confirm that an object is not in the safety area 115 when the first array detects an object to the left of the first threshold. In such a situation, the GO status may be maintained if there is confidence that the safety area 115 is clear when the first array detected the first object to be blocking its monitoring of the safety area 115.

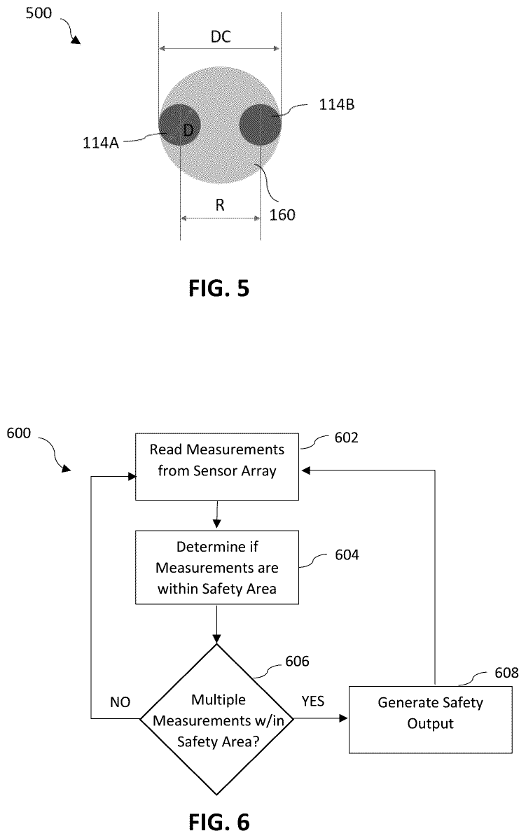

As a result, the protection device 100 enables the detection of a specific object (e.g., a person, a body part, etc.) that enters the safety area 115 and with a certain resolution. FIG. 5 shows an example detectable object represented by a cylinder of suitable diameter to illustrate the detection capability of the protection device. The diameter of the cylinder corresponds to the detection capability (DC). The certainty that a body of an object with defined DC intrusion may occur when at least two contiguous beams of the TOF sensor array have been intercepted within the safety area. As described above, the TOF sensors of the array may be equidistant from each other so that the distance between two consecutive TOF beams corresponds to the detection capability minus the maximum diameter of the emission beam spot. The TOF sensors may also be aligned so that they remain parallel to each other within the entire maximum detection distance for the sensible field 114.

FIG. 6 is a flow chart 600 illustrating a method for operating a scan sequence of the protective device according to an embodiment of the disclosure. In some embodiments, the protective device shall respond within a pre-defined response time during which the actions herein are to be performed.

At operation 602, the measurement for each TOF sensor of the sensor array may be read. At operation 604, it is determined if a measurement for a detected object is within the predefined safety area. For example, the measurement may be below a predetermined safety threshold that defines a safety area within the sensible field. In some embodiments, multiple safety thresholds may define the safety area. The measurement may be at a distance that is between the safety thresholds defining the safety area. This determination may be performed for the output of each TOF sensor of the sensor array.

At operation 606, it is determined how many consecutive sensors detected an object to be within the predetermined safety area. If that number of consecutive sensors is above a predetermined number, then the safety output is provided to the machine at operation 608. Otherwise, if the predetermined number of consecutive sensors detecting the object is less than the predetermined number, then the safety monitoring continues without providing a safety output. For example, if the predetermined number of sensors needed is set at two, then at least two consecutive (i.e., neighboring) sensors are needed to provide an output indicating that the object is at a distance from the sensors within the safety area in order to generate the safety output for the machine. If only one sensor detects the object is within the safety area, then the safety output may not be generated. As a result, smaller objects such as dust and/or debris related to operating a woodworking machine or other similar machine may not trigger the safety output. The set number of two consecutive sensors of the sensor array is provided as a non-limiting example, and other numbers are also contemplated.

In some embodiments, other alternatives are also contemplated including monitoring a set number of even sensors (e.g., sensors 2, 4, 6, etc. of the array) and/or odd sensors (e.g., sensors 1, 3, 5, etc. of the array). As a result, if consecutive even sensors (e.g., sensor 2 and sensor 4) of the array detect an object within the safety area at the same time, the safety output may be generated.

In some embodiments, the safety output may be generated in response to consecutive sensors detecting an object being within the safety area that is detected by the sensor array in an order that indicates the object is moving toward the machine, such as sensor 1, then sensor 2, etc. which are positioned in a way for their TOF beam to be furthest from the working surface (e.g., sensor 1), to a position that is closer to the working surface (e.g., sensor 2). Because this is the typical direction of movement for the operator to approach the machine, false positives from falling debris being detected within the safety area may be ignored by the controller when the measurements of individual TOF sensors of the sensor array do not occur in the expected order or read sequence.

In some embodiments, detecting an object within the safety area for the outer beams of the sensible field may be trigger a different response than the inner beams of the sensible field. For example, in some embodiments detecting an object within the safety area by outer beams (e.g., sensor 1 and sensor 2) may generate first safety output that generates an alert (e.g., audible or visual) without shutting off the machine, whereas detecting an object within the safety area by inner beams (e.g., sensor 2 and sensor 3, sensor 3 and sensor 4, etc.) may generate a safety output that shuts off the machine. As a result, the user may be informed that a potential dangerous situation was detected at a distance that is considered safe enough for the machine to remain operational so that the user take any precautions needed.

Embodiments of the disclosure may improve the performance for safety protection and reducing the impact from the presence of dust and/or debris in terms of machine availability. An autonomous and flexible optic system may be installed on the machinery (e.g., woodworking machinery). In such a way the machine may be free from fixed protection typical to conventional approaches, which can also enable the machine to be moved everywhere with its safety system according customer requirement without needing to separately move and re-install the protection device in new location. With the protection device installed on the machinery itself, moving the machinery with the protection device already in place.

Additional non-limiting embodiments include:
Embodiment 1. A protective device for a machine, comprising: a sensor array disposed on the machine, the sensor array having a plurality of time-of-flight (TOF) sensors arranged to form a sensible field for TOF measurements; and a controller operably coupled to the sensor array, the controller configured to: define a safety area within the sensible field; detect an object within the sensible field; and generate a safety output that controls an operation of the machine in response to the object being detected within the safety area.
Embodiment 2. The protective device of Embodiment 1, wherein the operation is turning off the machine.
Embodiment 3. The protective device of Embodiment 1 or Embodiment 2, wherein the controller is configured to generate the safety output only responsive to consecutive TOF sensors of the sensor array detecting the object within the safety area of the sensible field.
Embodiment 4. The protective device of any of Embodiments 1-3, wherein the controller is configured to define the safety area as an area of the sensible field less than a threshold value.
Embodiment 5. The protective device of any of Embodiments 1-4, wherein the controller is configured to define the safety area as an area of the sensible field between a first threshold value and a second threshold value.
Embodiment 6. The protective device of Embodiment 5, wherein the first threshold value and the second threshold value are user configurable values set by a user through a user interface operably coupled to the controller.
Embodiment 7. The protective device of any of Embodiments 1-6, wherein the sensor array is disposed on a movable head of the machine that is movable relative to a working plane of the machine.
Embodiment 8. The protective device of Embodiment 7, further comprising a head position TOF sensor disposed on the machine and a corresponding reflective material, and configured to determine a position of the movable head.
Embodiment 9. The protective device of Embodiment 8, wherein the head position TOF sensor is on the movable head, and the reflective material is disposed on a fixed portion of the machine.
Embodiment 10. The protective device of Embodiment 8 or Embodiment 9, wherein the controller is configured to adjust one or more threshold values defining the safety area responsive to the position of the movable head determined by the head position TOF sensor.
Embodiment 11. The protective device of any of Embodiments 1-10, wherein the TOF sensors of the sensor array are equidistant from each other and aligned so that emission beams remain substantially parallel through at least the safety area.
Embodiment 12. A method of operating a protective device, the method comprising: projecting a sensible field for TOF measurements from a sensor array having a plurality of time-of-flight (TOF) sensors disposed on a machine; and defining, via a controller of a protective device, a safety area within the sensible field of the sensor array; detecting an object within the sensible field via the controller coupled to the sensor array; and generating a safety output that controls an operation of the machine in response to the object being detected within the safety area.
Embodiment 13. The method of Embodiment 12, wherein controlling the operation of the machine includes turning off the machine.
Embodiment 14. The method of embodiment 12 or Embodiment 13, wherein controlling the operation of the machine includes: generating at least one of a visual or an audible alert without turning off the machine responsive to one or more outer TOF sensors of the sensor array detecting the object being within the safety area; and turning off the machine responsive to one or more inner TOF sensors of the sensor array detecting the object being within the safety area.
Embodiment 15. The method of any of Embodiments 12-14, further comprising detecting the object being within the safety area based on a plurality of TOF sensors of the sensor array simultaneously detecting the object being within the safety area.
Embodiment 16. The method of any of Embodiments 12-15, further comprising detecting the object being within the safety area based on a plurality of TOF sensors of the sensor array sequentially detecting the object being within the safety area in an expected order indicative of the object moving toward the machine.
Embodiment 17. A protective system, comprising: a machine; a protective device disposed on the machine for providing safety monitoring around the machine, the protective device comprising: a sensor array disposed on the machine, the sensor array having a plurality of time-of-flight (TOF) sensors arranged to form a sensible field for TOF measurements; and a controller operably coupled to the sensor array, the controller configured to: define a safety area within the sensible field; detect an object within the sensible field; and generate a safety output that controls an operation of the machine in response to the object being detected within the safety area.
Embodiment 18. The protective system of Embodiment 17, wherein the machine is a woodworking machine.
Embodiment 19. The protective system of Embodiment 17 or Embodiment 18, further comprising another protective device, wherein the protective device is disposed on a first side of the machine and the another protective device is disposed on a second side of the machine.
Embodiment 20. The protective system of Embodiment 19, wherein the first side of the machine and the second side of the machine are opposing sides of the machine.
Embodiment 21. The protective device of any of Embodiments 1-11, wherein the sensible field and/or safety area are generally rectangular in shape.
Embodiment 22. The method of any of Embodiments 12-16, wherein the sensible field and/or safety area are generally rectangular in shape.
Embodiment 23. The protective device of any of Embodiments 17-20, wherein the sensible field and/or safety area are generally rectangular in shape.

The foregoing method descriptions and/or any process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be communicated (e.g., passed, forwarded, and/or transmitted) via any suitable means including memory sharing, message passing, token passing, network transmission, etc.

The actual software code or specialized control hardware used to implement these systems and methods is not limiting of the disclosure. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of various preferred embodiments for implementing the disclosure, and the scope of the invention should not necessarily be limited by this description. The scope of the present invention is instead defined by the claims.

What is claimed:

1. A protective device for a machine, comprising:
a sensor array disposed on the machine, the sensor array having a plurality of time-of-flight (TOF) sensors arranged to form a sensible field for TOF measurements; and
a controller operably coupled to the sensor array, the controller configured to:
define a safety area within the sensible field;
detect an object within the sensible field; and
generate a safety output that controls an operation of the machine in response to the object being detected within the safety area.

2. The protective device of claim 1, wherein the operation is turning off the machine.

3. The protective device of claim 1, wherein the controller is configured to generate the safety output only responsive to consecutive TOF sensors of the sensor array detecting the object within the safety area of the sensible field.

4. The protective device of claim 1, wherein the controller is configured to define the safety area as an area of the sensible field less than a threshold value.

5. The protective device of claim 1, wherein the controller is configured to define the safety area as an area of the sensible field between a first threshold value and a second threshold value.

6. The protective device of claim 5, wherein the first threshold value and the second threshold value are user configurable values set by a user through a user interface operably coupled to the controller.

7. The protective device of claim 1, wherein the sensor array is disposed on a movable head of the machine that is movable relative to a working plane of the machine.

8. The protective device of claim 7, further comprising a head position TOF sensor disposed on the machine and a corresponding reflective material, and configured to determine a position of the movable head.

9. The protective device of claim 8, wherein the head position TOF sensor is on the movable head, and the reflective material is disposed on a fixed portion of the machine.

10. The protective device of claim 8, wherein the controller is configured to adjust one or more threshold values defining the safety area responsive to the position of the movable head determined by the head position TOF sensor.

11. The protective device of claim 1, wherein the TOF sensors of the sensor array are equidistant from each other and aligned so that emission beams remain substantially parallel through at least the safety area.

12. A method of operating a protective device, the method comprising:
projecting a sensible field for TOF measurements from a sensor array having a plurality of time-of-flight (TOF) sensors disposed on a machine;
defining, via a controller of the protective device, a safety area within the sensible field of the sensor array;
detecting an object within the sensible field via the controller coupled to the sensor array; and
generating a safety output that controls an operation of the machine in response to the object being detected within the safety area.

13. The method of claim 12, wherein controlling the operation of the machine includes turning off the machine.

14. The method of claim 12, wherein controlling the operation of the machine includes:
generating at least one of a visual or an audible alert without turning off the machine responsive to one or more outer TOF sensors of the sensor array detecting the object being within the safety area; and
turning off the machine responsive to one or more inner TOF sensors of the sensor array detecting the object being within the safety area.

15. The method of claim 11, further comprising detecting the object being within the safety area based on a plurality of TOF sensors of the sensor array simultaneously detecting the object being within the safety area.

16. The method of claim 11, further comprising detecting the object being within the safety area based on a plurality of TOF sensors of the sensor array sequentially detecting the object being within the safety area in an expected order indicative of the object moving toward the machine.

17. A protective system, comprising:
a machine;
a protective device disposed on the machine for providing safety monitoring around the machine, the protective device comprising:
a sensor array disposed on the machine, the sensor array having a plurality of time-of-flight (TOF) sensors arranged to form a sensible field for TOF measurements; and
a controller operably coupled to the sensor array, the controller configured to:
define a safety area within the sensible field;
detect an object within the sensible field; and
generate a safety output that controls an operation of the machine in response to the object being detected within the safety area.

18. The protective system of claim 17, wherein the machine is a woodworking machine.

19. The protective system of claim 17, further comprising another protective device, wherein the protective device is disposed on a first side of the machine and the another protective device is disposed on a second side of the machine.

20. The protective system of claim 19, wherein the first side of the machine and the second side of the machine are opposing sides of the machine.
